(19) United States
(12) Patent Application Publication
(10) Pub. No.: US 2021/0330129 A1
(43) Pub. Date: Oct. 28, 2021

(54) ADAPTER BETWEEN A DISPOSABLE CUP AND A BLENDER BLADE ASSEMBLY

(71) Applicants: Brant SWIDLER, New York, NY (US); Adam FEIST, Golden, CO (US)

(72) Inventors: Brant SWIDLER, New York, NY (US); Adam FEIST, Golden, CO (US)

(21) Appl. No.: 17/264,607

(22) PCT Filed: Aug. 2, 2019
(86) PCT No.: PCT/US2019/044925

§ 371 Date: Jan. 29, 2021

Related U.S. Application Data
(60) Provisional application No. 62/713,876, filed on Aug. 2, 2018.
(60) Provisional application No. 62/729,301, filed on Sep. 10, 2018.
(60) Provisional application No. 62/867,839, filed on Jun. 27, 2019.

(51) Int. Cl. A47J 43/07

(52) U.S. Cl. CPC A47J 43/0722

(57) ABSTRACT

An adapter for use with a blender to accommodate disposable cups.

### FIELD OF THE INVENTION

The invention relates to an adapter assembly for employing a disposable cup with a blender.

### BACKGROUND OF THE INVENTION

Blenders currently in the market, such as Magic Bullet, Nutribullet, Tribest, Vitamix, Ninja, Black and Decker, Bella, Hamilton Beach, Oster Blue, among others, offer the ability to blend inside a single-serve cup. These blenders typically include a special reusable cup threaded near the top and a separate threaded blade assembly designed to be screwed onto the reusable cup thus capping the cup and fully enclosing the ingredients inside the cup. A user places ingredients into the reusable cup, screws on the blade assembly, and then secures the cup and attached blade assembly to the blender motor housing to start the blending process. An advantage of such devices is that a serving can be prepared directly inside the reusable cup, which also makes cleaning easier.

Although these blenders blend the ingredients inside a “to go” reusable cup, these devices are not fully optimized for people “on the go,” as the user will still need to clean the cup and will need to take the reusable cup with her if she is going to drink the contents at a location remote from the blender. Take as an example of someone “on the go” a user who wants to make a smoothie before leaving for work. This person has three options after making the smoothie: 1) take the reusable cup to work and ultimately bring it home, 2) pour the smoothie into another cup and take that cup to work, or 3) drink the smoothie at home from the reusable cup.

To overcome these drawbacks, the present invention retrofits currently available blenders to blend directly inside a disposable cup. This also enables efficiency in meal preparation as a user can put food ingredients in multiple disposable cups and place them in a freezer. When ready, the user can take a cup from the freezer, add liquid, blend directly inside the disposable cup, and take the disposable cup “to go.”

Common disposable cups for 12 oz., 16 oz., 20 oz., 24 oz., and 30 oz. have standard diameters, usually between 3.3 in. and 4.5 in., depending on whether they are paper or plastic. Most common cup sizes measure approximately 3.9 in. (99 mm) in diameter, while most compostable PLA cups are 3.78 in. (96 mm) or 3.86 in. (98 mm) in diameter. Currently available blenders accommodate single-serve reusable cups ranging from 2.5 in. to 4.5 in. and have a variety of thread types. Thus, in most cases it is not possible to adapt the currently available blenders to blend directly inside a disposable cup due to size or design constraints.

There have been attempts to develop adapters for accommodating use of disposable cups with blenders. One approach requires two separate threaded connections to be tightened together to pinch the lip of a disposable cup in place. However, the need to combine two separate pieces makes assembly difficult and can also cause problems when tightening or loosening, depending on thread direction. There is also a risk that a user may unscrew the device while the blade is spinning and engaged. Another approach uses a custom-designed blender and a custom connection between a disposable cup and the blender. However this approach cannot be used with currently available household blenders. Another approach employs an adapter that threads onto a variety of blenders, but the adapter is designed only for a custom disposable cup and cannot be used with commonly available disposable cups. Another approach allows a cup to be threaded between a reusable cup and the blade assembly, but this approach only works when the reusable cup and the blade assembly have the same diameter as the disposable cup and when the blade assembly does not have to be pressed down to engage the blender motor. Consequently this approach will not work with many of the blenders currently on the market.

### SUMMARY OF THE INVENTION

The present invention provides an adapter assembly for retrofitting commercially available blenders to accommodate disposable cups, and more particularly an adapter assembly that receives a disposable cup and secures it to a blender blade assembly. An object of the present invention is to allow a disposable cup to be easily connected to the blade assemblies of a variety of currently available single-serve blenders without ruining the cup or exposing the user to the spinning blade. Another object of the invention is to provide such an adapter that is capable of use with common disposable cup sizes. Most blenders on the market require the user to push down on a reusable cup to engage the blender motor, such that if a disposable cup is substituted, there will be little or no protection from the sharp blades other than the material of the disposable cup. Therefore, further objects of the invention are to provide an adapter which includes a housing to protect the user from the blade, provide a simple way of removing the disposable cup from the housing, prevent the adapter from opening while the blade is spinning, avoid leaks, and allow the adapter and blade assembly to be easily attached and detached.

According to an aspect of the invention, an adapter assembly is provided for securing a disposable cup, e.g., a cup made of paper, plastic, biodegradable material, etc., to a blender blade assembly.

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention. It should be understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a top perspective view showing the adapter assembly of the present invention;

FIG. 2 is a side elevation thereof, the other side elevation being a mirror image of FIG. 2;

FIG. 3 is a rear elevation thereof;

FIG. 4 is a front elevation thereof;

FIG. 5 is a bottom plan view thereof;

FIG. 6 is an exploded perspective view thereof;

FIG. 7 is an exploded sectional view thereof;

FIG. 8 is non-exploded sectional view thereof;

FIG. 9 is a sectional view similar to FIG. 8, but showing the adapter assembly in an open position ready to receive a disposable cup;

FIG. 10 is a view similar to FIG. 9, but showing the disposable cup inserted in the adapter assembly;

FIG. 11 is a view similar to FIG. 10, but with the adapter assembly in the closed position wherein the disposable cup is held securely in place;

FIG. 12 is a view similar to FIG. 11, but with the with the blender blade assembly attached to the adapter assembly;

FIG. 13 is a partial sectional view similar to FIG. 12, but showing the adapter assembly and attached blender blade assembly secured to the blender's motor housing;

FIG. 14 is an exploded sectional view of a first alternative embodiment of the present invention;

FIG. 15 is an exploded sectional view of a second alternative embodiment of the present invention;

FIG. 15a is a side elevation of the second alternative embodiment;

FIG. 16 is an exploded sectional view of a third alternative embodiment of the present invention; and

FIG. 17 is an exploded sectional view of a fourth alternative embodiment of the present invention.

In the drawings, the reference numerals refer to the following features:
100—Adapter assembly;
200—Coupling;
202—Threaded portion of coupling;
204—Connecting wall;
204A—Hinge pin;
206—Latch coupling;
206A—Vertical walls of latch coupling;
206B—Shelf of latch coupling;
206C—Indent in shelf of latch coupling;
208—Annular gasket;
210—Locking members on coupling member;
212—Annular skirt on coupling member;
214—Annular recess;
216—Annular shoulder on coupling;
218—Cylindrical extension internal thread;
220—Annular shoulder;
222—Cylindrical extension;
224—Female connector element;
226—Locking pins;
228—Hinge;
230—Annular skirt;
300—Cup holder;
301—Drain Holes;
302—Body of cup holder;
302A—Holes;
304—Upper portion of cup holder;
306—Vertical members;
306A—Thru-holes in vertical protrusions;
308—Gaps for finger access;
310—C-shaped grips;
312—Annular Ledge;
313—Vertical wall joining ledges 312, 314;
314—Annular Ledge;
315—Vertical wall joining ledges 314, 316;
316—Annular Ledge;
318—External thread;
320—Male connector element;
322—Removed section of housing;
324—Annular shoulder;
326—Openings;
400—Latch;
402—Latch hinge;
402A—Cylindrical protrusions;
404—Latch hook;
404A—Latch bar;
406—Latch arm;
408—Locking member;
410—Latch wall;
500—Cup;
502—Lip of cup;
600—Blender blade assembly;
602—Blender motor base;
604—Blender blades; and
700—Combined blade assembly and coupling.

### DETAILED DESCRIPTION OF THE PRESENTLY PREFERRED EMBODIMENTS

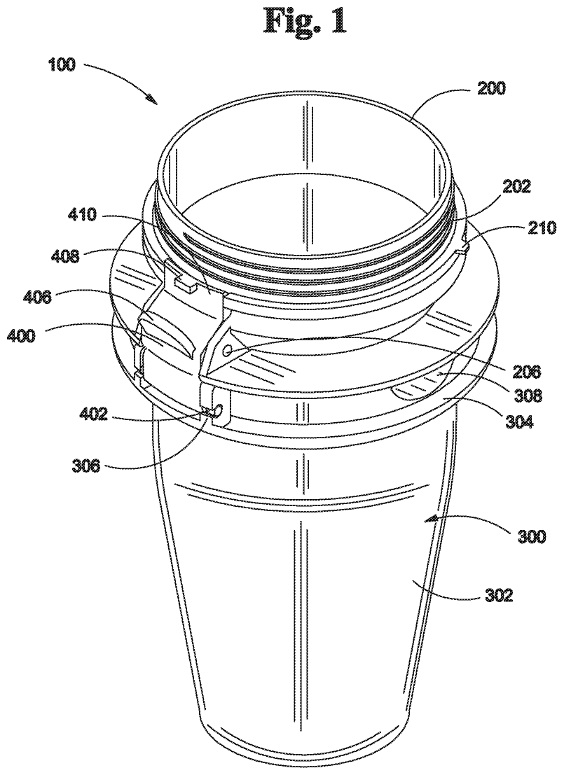

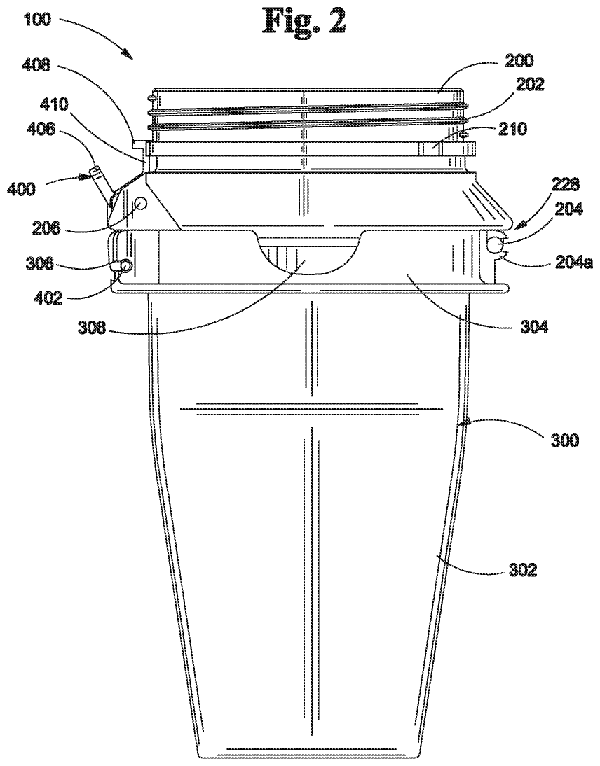

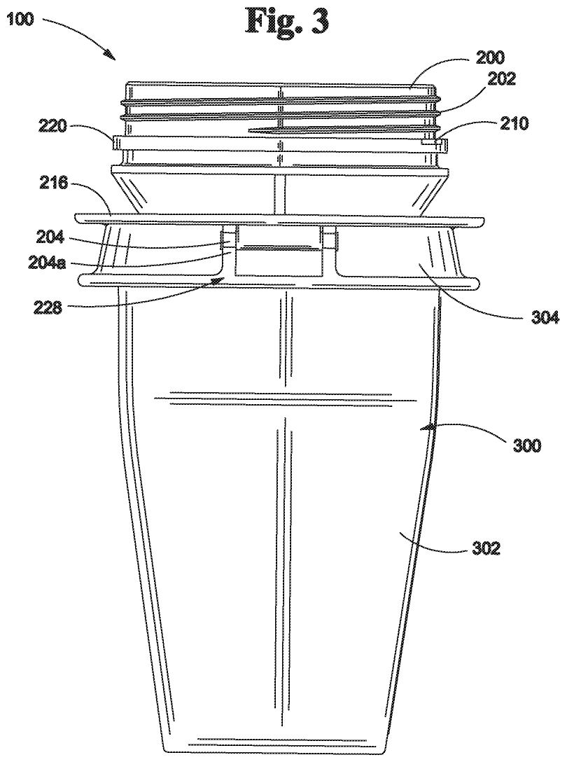

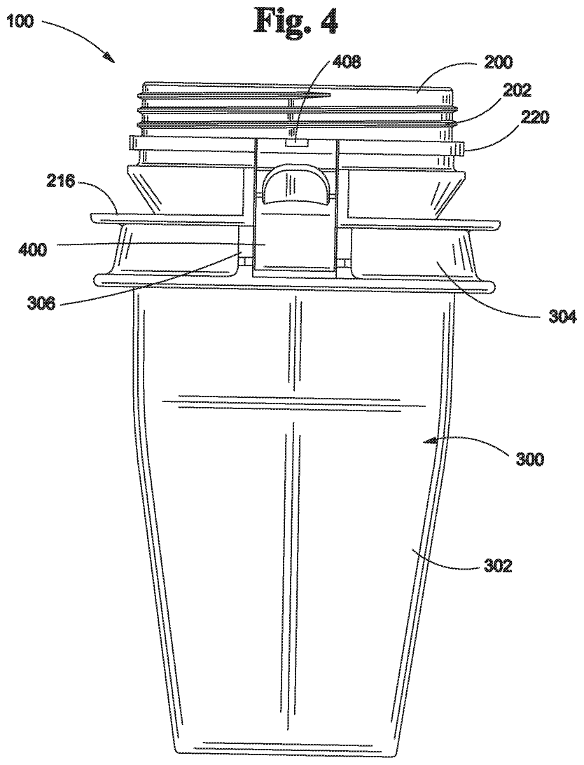

FIGS. 1-4 illustrate one embodiment of the present invention for using a disposable cup with a single-serve blender. As shown, the adapter assembly 100 includes a coupling 200 and a housing 300, a hinge 228 on one side of the coupling for rotatably joining the coupling 200 to the housing 300, and a latch 400 for securing the other side of the coupling 200 to the housing 300 in a closed position.

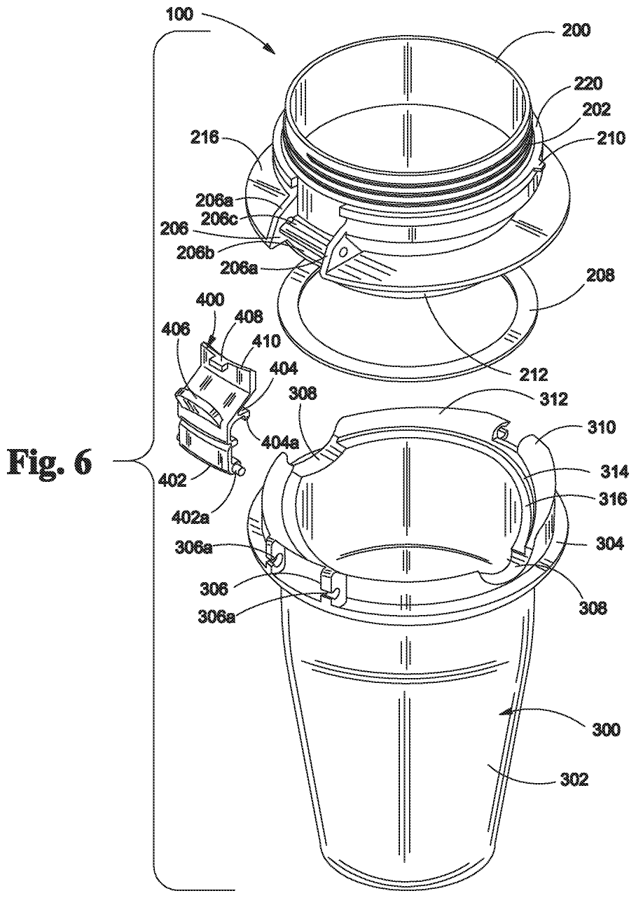

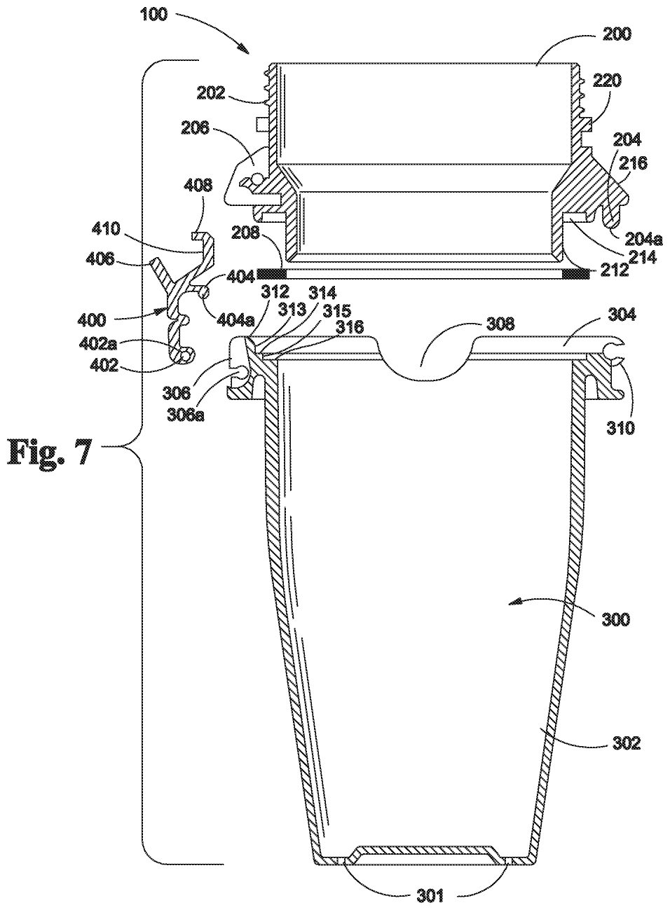

Referring to FIGS. 6 and 7, the housing 300 has a tapered, cylindrical shape open at one end for receiving a disposable cup. The open end of the housing has three annular ledges 312, 314 and 316. The ledge 316 is dimensioned such that when a disposable cup 500 is placed in the housing 300, the bottom of the rolled lip of the cup seats on the ledge 316. For disposable cups that do not have a rolled lip, the height of the housing 300 would be set such that the bottom of the cup will be in contact with and supported by the bottom of the housing with the top of the cup adjacent the top of the housing. The circular ledge 314 is above the ledge 316 and encircles it, ledges 314, 316 being joined by a generally vertical wall 315. When the coupling 200 is secured to the housing 300 in the closed position, an annular sealing gasket 208 abuts the shoulder 314. Ledge 312, at the very top of the housing 300, is above the ledge 314 and encircles it, ledges 312, 314 being joined by a generally vertical wall 313. As shown, and for reasons explained below, diametrically opposed portions of the ledges 312, 314, 316 and walls 313, 315 are removed to provide finger access points 308.

Still referring to FIGS. 6 and 7, the upper end of the housing 300 includes two spaced apart C-shaped grips 310 which comprise part of the hinge 228. A section of the uppermost ledge 312 is removed between the grips 310. Two vertical members 306 opposite the grips 310 extend from the exterior wall of the housing 300. Each vertical member 306 has a transverse thru-hole 306a open at its outer edge. As explained below, the vertical members 306 engage the latch 400 for retaining the coupling 200 in a closed position on housing 300.

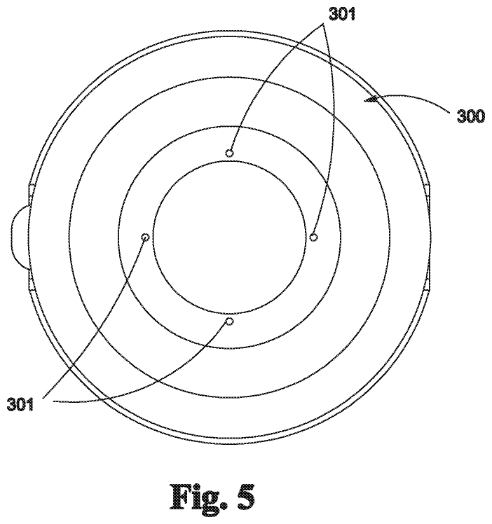

The body 302 of the housing 300 has a tapered cylindrical shape larger than the shape of a common disposable cup and a height taller than the height of a common disposable cup, such that a disposable cup can be inserted in the housing 300 with the lip of the cup resting on the ledge 316. As noted above, if the cup does not have a rolled lip, then the housing would be sized such that the bottom of the cup seats on the bottom of the housing 300 with the top of the cup adjacent the top of the housing. As shown in FIG. 5, the bottom of the body 302 has drain holes 301.

The coupling 200 is generally ring-shaped. The upper end of the coupling 200 has an externally threaded section 202 and an outwardly extending annular shoulder 220 below the threaded section. The shoulder 220 has two diametrically opposed gaps, one for accommodating grips 310 on housing 300 and one for accommodating latch 400. The diameter of the shoulder 220 will depend on the particular blender make and model for which the adapter 100 is intended, and in some cases the shoulder 220 will include spaced-apart outwardly extending locking members 210 which mate with corresponding openings in the blender motor housing. The coupling 200 also includes another annular shoulder 216 beneath the shoulder 220, the outer diameter and width of the shoulder 216 being larger than the outer diameter and width of shoulder 220. Like the shoulder 220, the shoulder 216 has two diametrically opposed gaps, one for accommodating grips 310 on housing 300 and one for accommodating latch 400. When the coupling 200 is secured to the housing 300 in the closed position, the bottom of the shoulder 216 sits on the ledge 312.

Coupling 200 has a latch coupling 206 comprising two spaced-apart vertical walls 206a with a shelf 206b having an indent 206c extending therebetween, the spacing between the walls 206a being the same as the spacing between the vertical members 306 on the housing 300. As best seen in FIG. 7, a connecting wall 204 having a hinge pin 204a at its free end extends downwardly from the shoulder 216 diametrically opposite the latch coupling 206. The width of the connecting wall 204 is smaller than the gap in the ledge 312 between the C-shaped grips 310 on the housing 300, the width of the pin 204a is wider than the spacing between the grips 310, and preferably the diameter of the pin 204a is slightly larger than the size of the openings in the C-shaped grips 310. The coupling 200 is rotatably and releasably secured to the housing 300 by aligning the pin 204a with the openings in the C-shaped grips 310 and then pressing the pin through the openings whereupon the pin is rotatable in the C-shaped grips for accommodating rotatable movement of the coupling 200 relative to the housing 300 for moving the coupling between its open and closed positions.

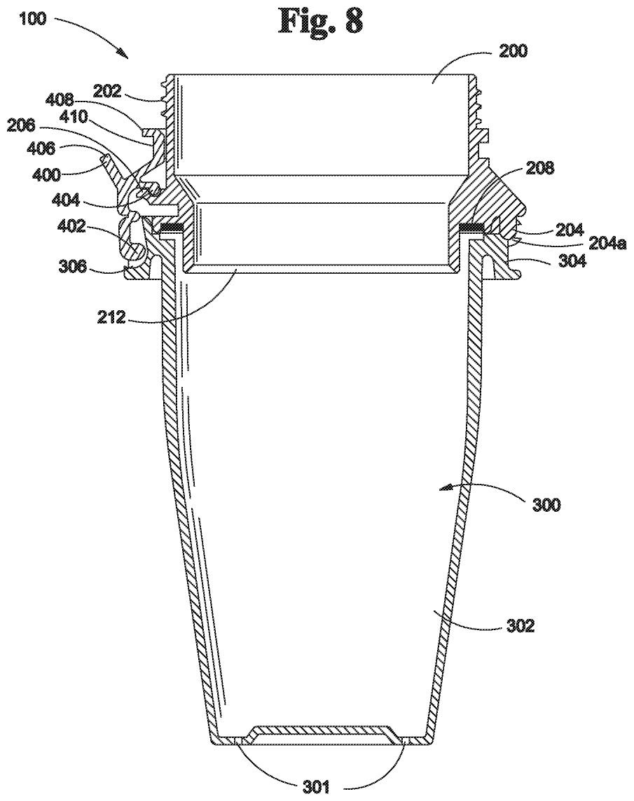

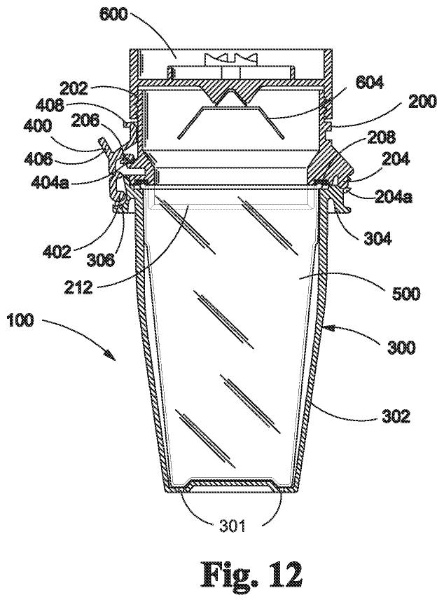

Still referring to FIG. 7, an annular recess 214 formed in the bottom of annular shoulder 216 defines a housing for annular gasket 208. As shown in FIG. 11, when the coupling 200 is in the closed position with a disposable cup 500 in the housing 300, the gasket 208 seats on top of the lip of the cup. As best shown in FIGS. 7 and 8, coupling 200 also includes a downwardly extending annular skirt 212. As will be apparent hereinafter, with a disposable cup 500 in the housing 300 and the coupling 200 in the closed position, the skirt 212 abuts the inside of the mouth of the disposable cup and, together with gasket 208, prevents leakage during blending.

Referring to FIGS. 6 and 7, the latch 400 includes a hinge bar 402 having reduced diameter cylindrical protrusions 402a at either end. The spacing between the protrusions 402a matches the spacing between the vertical members 306 and the diameter of the protrusions is preferably slightly larger than the size of the open ends of the thru-holes 306a such that latch 400 may be releasable secured for rotation relative to housing 300 by snapping the protrusions 402A into the open end of thru-holes 306a. A latch hook 404 extending the full width of the latch 400 extends from the inner surface of the latch 400. The latch hook 404 has a cylindrical latch bar 404a at its free end dimensioned to firmly seat in the recess or indent 206c in the shelf 206b of the latch coupling 206 when the latch 400 is closed, thereby securing coupling 200 to housing 300. Latch 400 also has an arm 406 extending from the outer surface of the latch which functions as a lever for manipulating the latch, and an upper vertical wall 410 having an inner curved surface which complements the curvature of the outer wall of the coupling 200 and seats against the outer wall of the coupling when the latch is closed. A locking member 408 extends outwardly from the wall 410. Like locking members 210, the locking member 408 mates with a corresponding opening in the blender motor housing during the blending process. Placing a locking member 408 on the latch 400 ensures that the blender motor will only be activated when the latch 400 is closed for securing coupling 200 to housing 300, as most blenders require mating of locking members 210, 408 with corresponding openings in the blender motor housing to activate the blender motor.

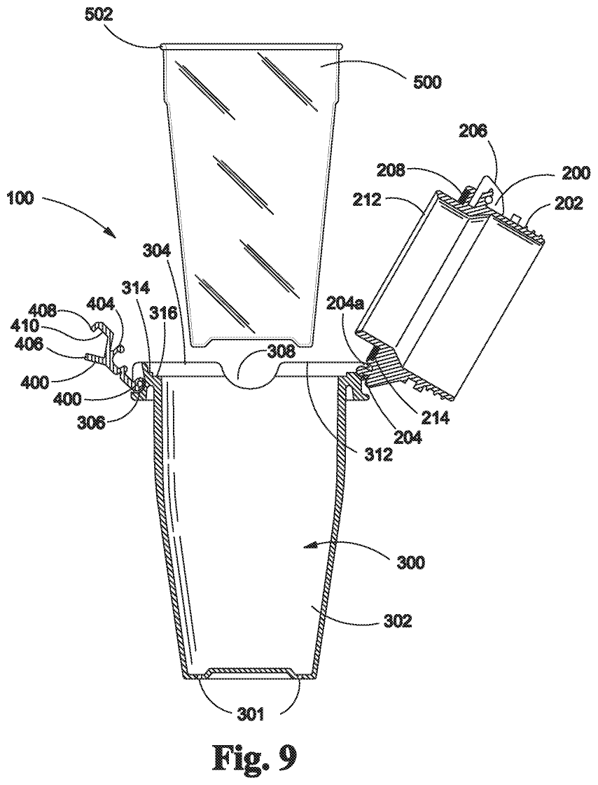

As best shown in FIGS. 9-11, and as should by now be apparent, the adapter assembly 100 is assembled by inserting gasket 208 in annular recess 214 of coupling 200, inserting lock pin 204a in C-shaped grips 310, and snap fitting protrusions 402a on latch 400 in thru-holes 306a. A disposable cup 500 with user-selected ingredients therein may then be inserted in the open end of the housing 300 until the lip of the cup seats on the ledge 316 of the housing. The coupling 200 may then be pivoted about the pin 204a to its closed position atop the housing 300 whereupon the latch 400 may be rotated upward and snapped into the recess 206c on the shelf 206b of the latch coupling 206, thereby securing the coupling 200 to the housing 300 and securing the lip of the cup between the gasket 208 and the ledge 316. As noted above, if the cup 500 does not have a lip the base of the disposable cup 500 will be supported by the bottom of the housing 300.

When the latch 400 is closed, the latch wall 410 is flush against the outer wall of the coupling 200 where a section of the annular shoulder 220 has been removed for this purpose (FIG. 5). When the coupling 200 is in the closed position the annular skirt 212 on the coupling 200 extends into the mouth of the housing 300 and abuts the upper portion of the inner wall of the cup 500. The combination of the gasket 208 and skirt 212 provide sealing against leakage during the blending process. More particularly, the skirt 212 prevents the centrifugal forces generated during the blending process from compromising the sealing interface between the gasket 208 and the lip 502 of cup 500, thus reducing the compression pressure between the gasket 208 and the lip 502 required to create a liquid-tight seal. In an alternative embodiment the gasket 208 may be disposed in a recess in the outer surface of the skirt 212 such that when the coupling 200 is in the closed position, the gasket will create a seal by pressing against the interior wall of the cup 500. However, this configuration may make it more difficult to open the coupling 200 as the gasket 208 may suction to the cup 500.

The two diametrically opposed gaps 308 in the ledges 312, 314, 316 allow the user to place her fingers under the lip 502 of the cup 500 while placing the cup 500 in the housing 300 and removing it therefrom. Without the finger access provided by the gaps 308 the user would have to drop the cup 500 into the housing 300 which might result in spillage. For this purpose, the gaps 308 should be slightly larger than the average thumb. When the adapter assembly is closed, the lip 502 of the cup 500 will not be in contact with the gasket 208 at the gaps 308, so the gaps should not be so large as to result in insufficient pressure holding the lip 502 securely in place.

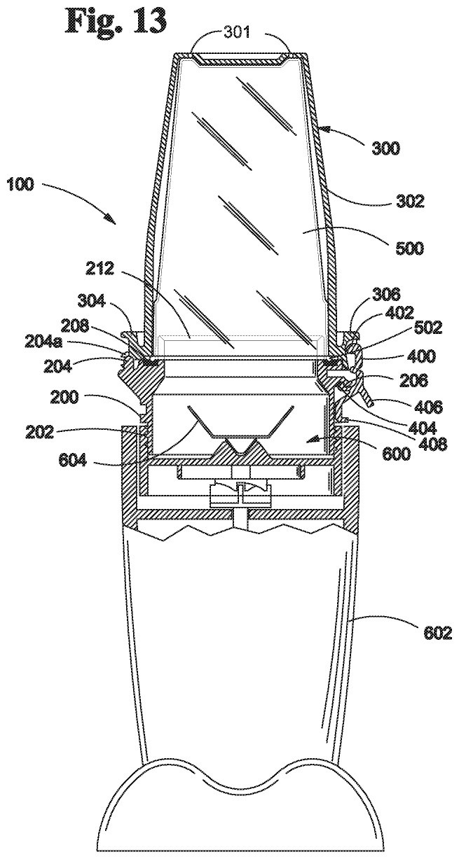

Referring to FIG. 12, with the coupling 200 in the closed position, the user can thread the blender blade assembly 600 onto the coupling 200. The diameter and threading on the threaded portion 202 of the coupling 200 will depend on the model/brand of blender, and for some blenders the threading will be relocated to the inner wall of the coupling 200.

It will be appreciated that the above-described order of steps for assembling the adapter 100 and attaching the blade assembly 600 is not exclusive and that a different ordering of the steps may be employed with like effect. For example, the user can first attach the blade assembly 600 to the coupling 200, then attach the coupling/blender blade subassembly to the housing 300 with the coupling in the open position, then attach the latch 400 to the housing 300, then place the disposable cup 500 with its ingredients in the housing 300, then move the coupling/blender blade subassembly to the closed position, and then secure the coupling to the housing by closing the latch 400. In any event, once the adapter is assembled, it will be apparent that the coupling 200 can be opened for inserting/removing a disposable cup 500 by first opening the latch 400 by pressing down on the arm 406 for unseating the latch bar 404a from the recess 206c, and then pivoting the coupling about the pin 204a to the open position whereupon the cup 500 may be inserted/removed from the housing 300.

FIG. 12 shows the fully assembled adapter assembly 100 with a disposable cup 500 therein attached to a typical blender blade assembly 600 having a blender blade 604. It will be appreciated that with the blade assembly 600 screwed onto the coupling 202, the cup 500 and the ingredients therein are completely enclosed in the interior space defined by the conjoined housing 300, coupling 200, and blade assembly 600, and that the ingredients in the cup can be contacted by the blender blade 604 without leakage.

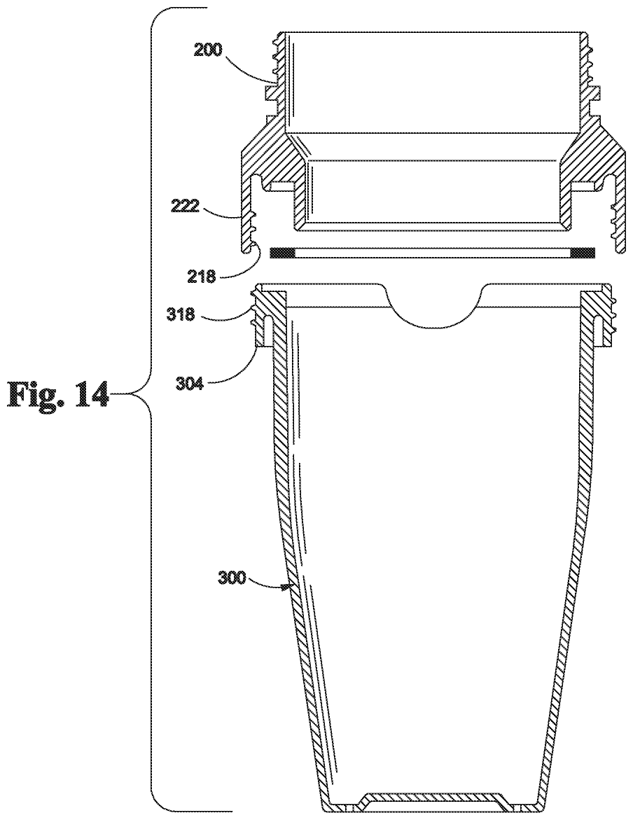

FIG. 13 shows the conjoined housing 300, coupling 200, and blade assembly 600 turned upside down with the blade assembly 600 mated with blender motor base 602 in the usual manner for the particular blender being used. For some commercially available blenders the act of pressing the blade assembly 600 into the motor base 602 will activate the motor for spinning the blade 604, while for other models it will be necessary to activate a separate switch to turn the motor on. In either case, It will be apparent that with the adapter assembly 100 and blade assembly 600 positioned as shown in FIG. 13, the ingredients in the cup 500 will move under the influence of gravity into contact with the rotating blade 604, thus blending the ingredients together to create a smoothie or other drink depending on the particular ingredients being used. During blending the housing 300 protects the user from exposure to the spinning blade 604. The housing 300 also provides a rigid structure which can be pushed down for mating the blade assembly with the motor base.

For most common blenders, the locking members 210, 408 will seat in openings in the blender motor base 602 where they either engage a switch that activates the blender motor or engage a locking mechanism which then allows the user to activate the blender motor via a separate switch on the motor base 602. During blending, the latch 400 remains closed and maintains pressure between the gasket 208 and the lip 502 of the cup 500. The latch 400 cannot be opened without disengaging the locking member 408 from the motor base 602 which will stop the blade 604 from spinning, and thus the latch 400 protects the user from potential harm by preventing the adapter assembly 100 from being opened while the blade 604 is spinning.

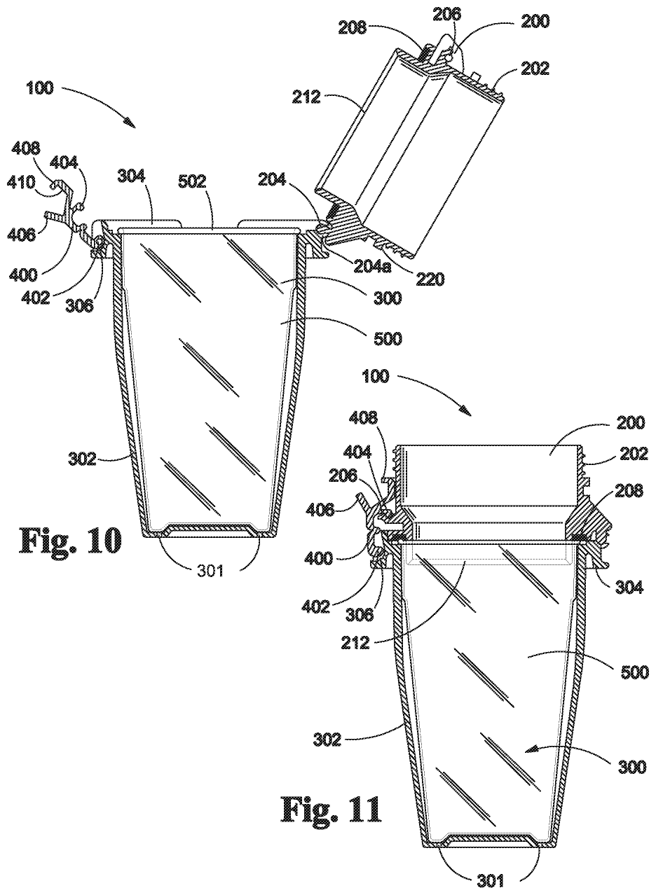

Once blending is complete, the user can disengage the adaptor assembly 100 and attached blade assembly 600 from the motor housing 602 in the usual manner, and then flip the adapter assembly 100 and attached blade assembly 600 back to the upright position seen in FIG. 12. Before or after disengaging the blade assembly 600 from the coupling 200, the user can disengage the coupling 200 form the housing 300 by opening latch 400 by pressing down on arm 406 and then pivoting the coupling 200 to the open position seen in FIG. 10. The user can then remove the disposable cup 500 from the housing 300 by grabbing the lip 502 at the finger access points 308. In some cases the blending process may create suction between the lip 502 of the cup 500 and the gasket 208. However, in that event the act of opening the coupling 200 will slowly peel gasket 208 off of the lip 502.

Once the cup 500 is removed from the housing 300, the coupling 200 and blade assembly 600 will likely need to be cleaned. This can be done with or without the coupling 200 attached to the housing 300 and with or without the blade assembly 600 attached to the coupling 200, though separating all of the parts may make cleaning easier.

It will be appreciated that the adapter assembly 100 allows a user to:

a) Prepare ingredients in a disposable cup;

b) Place the disposable cup in the adapter;

c) Lock the cup into position in the adapter;

d) Attach the blender blade assembly to the adapter, either before or after placing the disposable cup in the adapter;

e) Blend the food (soup/smoothie/whatever) inside the disposable cup;

f) Unlock the adapter and open the coupling;

g) Take out the disposable cup;

h) Clean the coupling and blade assembly; and

i) Enjoy and toss, i.e., dispose of, the cup when done.

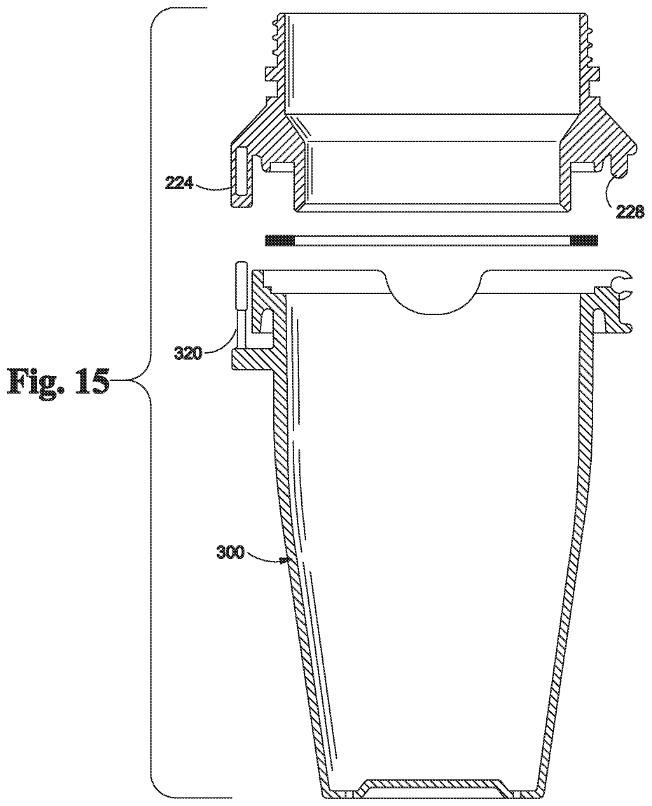

In an alternative embodiment shown in FIG. 14, the coupling 200 has an internally threaded downwardly extending cylindrical skirt 222 and the upper portion 304 of the housing 300 has a complementary external thread 318. As with the embodiment of FIGS. 1-13, threading the coupling 200 onto the housing 300 presses the lip 502 of the cup 500 against the gasket 208. The coupling 200 still includes the skirt 212 which, as explained above, reduces the extent to which the coupling must be tightened to the housing to prevent leakage. This embodiment may not be as desirable as the embodiment of FIGS. 1-13 to the extent it requires two threaded connections on the coupling, one for joining the coupling to the housing 300 and one for joining the coupling to the blade assembly 600. However, because the user need not tighten the coupling to the housing with maximum compression, it will be easier to unscrew the coupling from the housing without also loosening the blade assembly from the coupling.

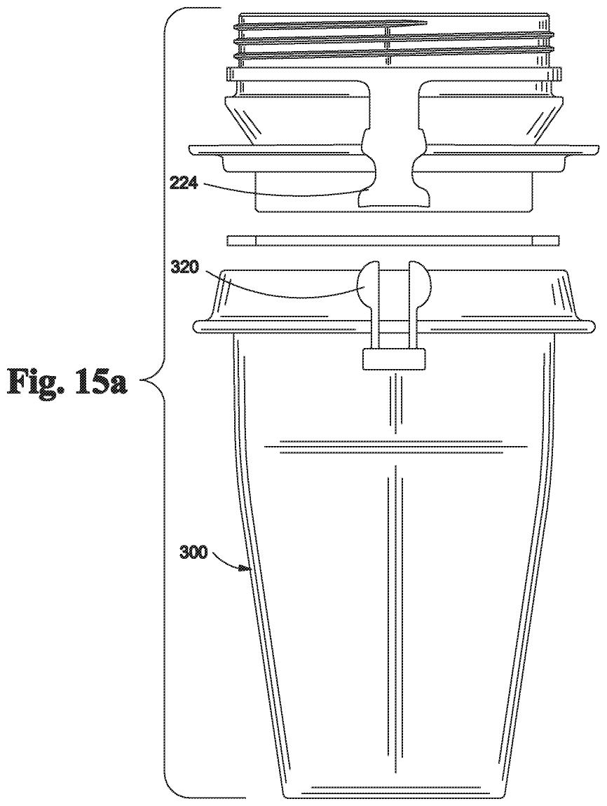

In another alternative embodiment shown in FIGS. 15 and 15a, the coupling 200 and housing 300 are joined by a snap fit connection. As shown, in lieu of latch 400, latch coupling 206, and vertical members 306, the coupling 200 includes female connector element 224 and housing 300 includes male connector element 320. As with the embodiment of FIGS. 1-13, the coupling is first joined to the housing by seating pin 204a in the C-shaped grips 310, whereupon the coupling may be rotated to the closed position and secured to housing 300 by forcing male element 320 into releasable engagement with female element 224, thus sealing the lip 502 of the cup 500 against the gasket 208 in the manner described above for the embodiment of FIGS. 1-13.

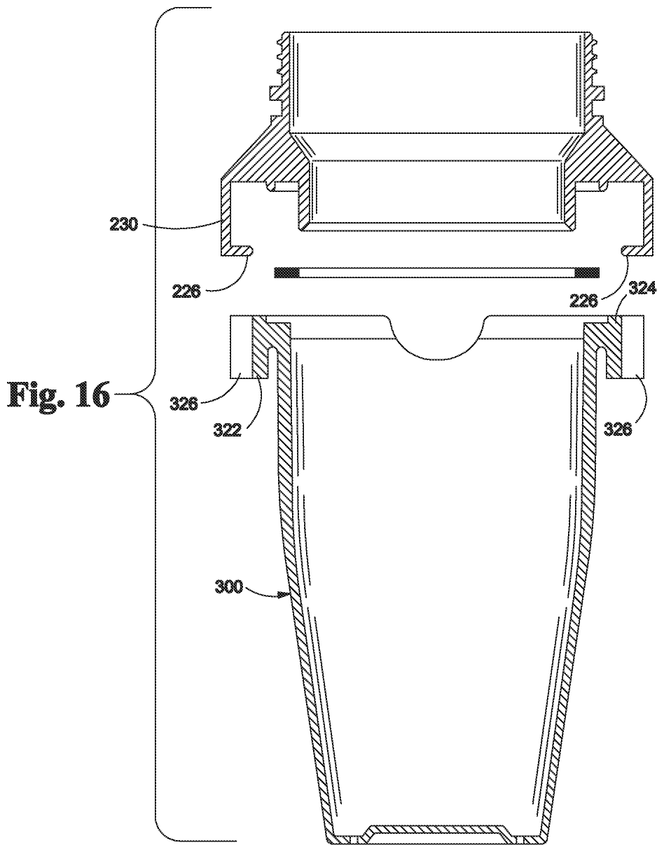

In a still further alternative embodiment shown in FIG. 16, in lieu of connecting wall 204, pin 204A, C-shaped grips 310, latch coupling 206, vertical walls 306, and latch 400, the coupling 200 has an outer downwardly extending skirt 230 with diametrically opposed inwardly extending locking pins 226 at its free end, and the upper portion of the housing 300 has an outer annular shoulder 324 with complementary thru-openings 326. In this embodiment the coupling is secured to the housing by aligning pins 226 with openings 326 and then pushing the coupling down so that the pins pass through the openings until they are below the lower surface 322 of the shoulder 324 whereupon the coupling may be rotated relative to the housing to a position in which the locking pins are in contact with the surface 322 for securing the coupling to the housing. Preferably each pin 226 has a nib on its upper surface and the surface 322 has corresponding indents into which the nibs are received when the coupling is rotated to the closed position thereby providing a tactile indication that the coupling is in a locked position in which the lip of the disposable cup is secured between the gasket 208 and an annular ledge in the upper portion of the housing as described above for the embodiment of FIGS. 1-13. The coupling 200 is removable from the housing 300 by pressing down on the coupling for releasing the nibs from the indents and then rotating the coupling relative to the housing until the pins 226 are aligned with the openings 326 whereupon the coupling may be lifted away from the housing.

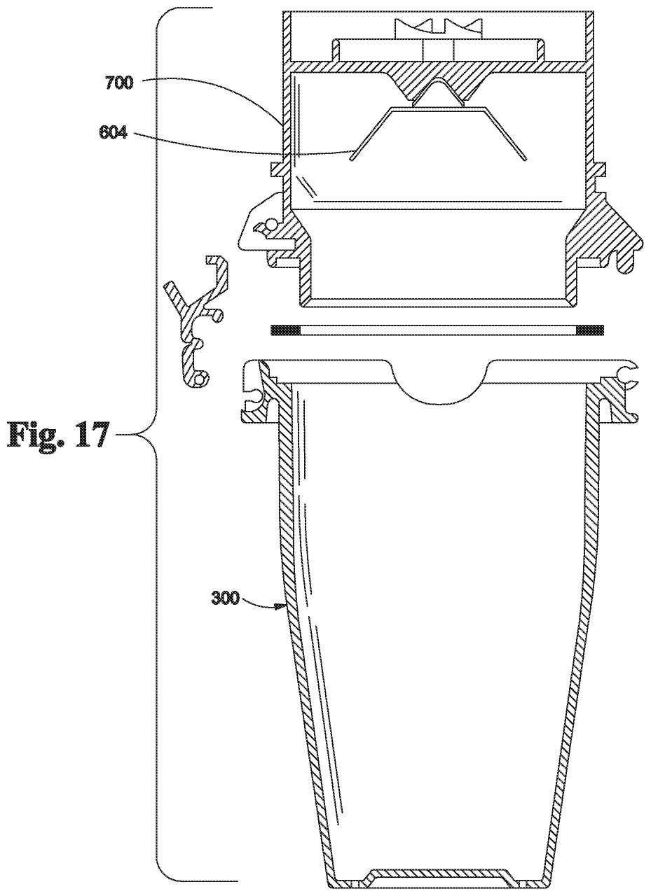

The further alternative embodiment shown in FIG. 17 is similar to the embodiment of FIGS. 1-13, except that in this embodiment the coupling and blade assembly are formed as an integral unit thereby eliminating the need for joining them together. It will be apparent that this alternative can also be used with any of the other embodiments described hereinabove for securing the coupling to the housing.

Although the embodiments disclosed above contemplate that the adapter assembly will be offered separately for use with commercially available blenders, it is within the scope of the invention to offer the adapter assembly 100 together with a compatible blender motor and blender blade assembly, or, in the case of the embodiment of FIG. 17, with a compatible blender motor.

The invention is not limited by the embodiments described above which are presented as examples only but can be modified in various ways within the scope of protection defined by the appended patent claims. Thus, while there have been shown and described fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed embodiment of the invention may be incorporated in any other disclosed or suggested embodiment as a general matter of design choice. It is the intention, therefore, to be limited only by the scope of the claims.

1. An adapter for use with a blender motor housing and a detachable blade assembly, one end of the blade assembly being releasably securable to the blender motor housing for rotating the blades on the blade assembly for blending food ingredients, comprising:
a rigid, reusable container having an open upper end with an annular ledge, the interior of the container having a circular cross section dimensioned to receive a disposable cup having a lip on its upper end with the bottom of the lip seating on the annular ledge;
an annular coupling member joined at one end to the other end of the blade assembly in coaxial alignment therewith, the other end of said coupling member having an annular surface;
means for releasably securing the other end of the coupling member to the upper end of the container in a closed position wherein the annular surface of the coupling member abuts the top of the lip of the cup for releasably securing the lip of the cup between the annular surface on the coupling member and the annular ledge on the container when a disposable cup is in the container and for preventing food ingredients in the disposable cup from leaking at the interface of the coupling member and the container, and at least one opening in the upper end of the container into which a user's finger may be inserted for facilitating placement of a disposable cup in the container and removal of a disposable cup therefrom.

2. The adapter of claim 1, wherein the means for releasably securing the other end of the coupling member to the upper end of the container comprises a hinge joining said one end of the coupling member to the upper end of the container for pivotal motion of said coupling member between said closed position and an open position wherein said coupling member is pivoted away from said container for exposing the upper end thereof.

3. The adapter of claim 2, wherein said hinge comprises a first hinge member on the coupling member and a second hinge member on the container, the first and second hinge members being releasably joinable for defining said hinge.

4. The adapter of claim 2, wherein the means for releasably securing the other end of the coupling member to the upper end of the container further comprises a latch member opposite the hinge, the latch member being pivotally attached at one end to one of the coupling member and the container and having a lock member at the other end which is releasably securable to the other one of the coupling member and the container for securing the coupling member in the closed position.

5. The adapter of claim 4, wherein the other one of the coupling member and the container has a surface with a recess, and wherein the lock member comprises a protrusion that seats in said recess for releasably securing the coupling member in the closed position.

6. The adapter of claim 5, wherein the latch member has an arm extending outwardly therefrom for applying a pivotal force to the latch member for releasing the lock member from the recess, whereupon the coupling member is movable to the open positon by rotating the coupling member about the hinge.

7. The adapter of claim 4, wherein the coupling member has a plurality of radially outwardly extending tabs engageable with openings in the blender motor housing for activating the motor in the blender motor housing when said one end of the blade assembly is secured to the blender motor housing, and wherein one of said tabs is disposed on the latch member and engageable with an opening in the blender motor housing only when the lock member is seated in said recess.

8-13. (canceled)

14. The adapter of claim 2, wherein said means for releasably securing the other end of the coupling member to the upper end of the container in a closed position comprises a releasable locking mechanism opposite the hinge, the locking mechanism comprising a male member on one of said coupling member and said container and a female member on the other of said coupling member and said container, said male member being dimensioned for a releasable force fit in said female member when said coupling member is in said closed position.

15. The adapter of claim 1, wherein said means for releasably securing the other end of the coupling member to the upper end of the container in a closed position comprises said other end of said coupling member having an outer annular wall having a plurality of radially inwardly projecting extensions at the free end thereof and said container having an annular shoulder at the upper end thereof, said shoulder having a bottom surface and plurality of openings therein alignable with said extensions on said coupling member, said extensions being dimensioned to pass through said openings in said shoulder whereupon said coupling member may be rotated relative to said container for moving said extensions into contact with said bottom surface of said shoulder for releasably securing said coupling member in the closed position.

16. (canceled)

17. (canceled)

18. An adapter for use with a blender motor housing and a detachable blade assembly, one end of the blade assembly being releasably securable to the blender motor housing for rotating the blades on the blade assembly for blending food ingredients, comprising:
a rigid, reusable container having an open upper end with an annular ledge, the interior of the container having a circular cross section dimensioned to receive a disposable cup having a lip on its upper end with the bottom of the lip seating on the annular ledge;
an annular coupling member joined at one to the other end of the blade assembly in coaxial alignment therewith, the other end of said coupling member having an annular surface;
a mechanism releasably securing the other end of the coupling member to the upper end of the container in a closed position wherein the annular surface of the coupling member abuts the top of the lip of the cup for releasably securing the lip of the cup between the annular surface on the coupling member and the annular ledge on the container when a disposable cup is in the container and for preventing food ingredients in the disposable cup from leaking at the interface of the coupling member and the container, the mechanism comprising a hinge joining said one end of the coupling member to the upper end of the container for pivotal motion of said coupling member between said closed position and an open position wherein said coupling member is pivoted away from said container for exposing the upper end thereof, and a latch member opposite the hinge, the latch member being pivotally attached at one end to one of the coupling member and the container and having a lock member at the other end which is releasably securable to the other one of the coupling member and the container for securing the coupling member in the closed position, and wherein the coupling member has a plurality of radially outwardly extending tabs which engage openings in the blender motor housing for activating the motor in the blender motor housing when said one end of the blade assembly is releasably secured to the blender motor housing, one of said tabs being disposed on the latch member for engagement with one of said openings in the blender motor housing only when the lock member is releasably secured to the other one of the coupling member and the container.

19. The adapter of claim 18, wherein the other one of the coupling member and the container has a surface with a recess, and wherein the lock member comprises a protrusion that seats in said recess for releasably securing the coupling member in the closed position.

20. The adapter of claim 19, wherein the latch member has an arm extending outwardly therefrom for applying a pivotal force to the latch member for releasing the lock member from the recess, whereupon the coupling member is movable to the open positon by rotating the coupling member about the hinge.

21. The adapter of claim 18, wherein the container has a bottom surface having one or more openings therein.

22. The adapter of claim 18, further comprising at least one opening in the upper end of the container into which a user's finger may be inserted for facilitating placement of a disposable cup in the container and removal of a disposable cup therefrom.

23. (canceled)

24. The adapter of claim 18, wherein the annular surface on said coupling member has an annular recess therein, and further comprising an annular gasket seated in said annular recess for engagement with the top of the lip of the cup when the coupling member is in the closed position and a disposable cup is in the container.

25. The adapter of claim 18, wherein the other end of the coupling member has an annular skirt and wherein when the coupling member is in the closed position the annular skirt abuts the upper portion of the interior wall of the disposable cup when a disposable cup is in the container.

26. The adapter of claim 25, wherein the annular skirt has an annular recess in the outer wall thereof, and wherein an annular gasket is seated in said annular recess for engagement with the interior wall of a disposable cup when a disposable cup is in the container and the coupling member is in the closed position.

27. The adapter of claim 18, wherein said other end of said blade assembly has threading thereon, said one end of said coupling member has threading thereon, and wherein said coupling member is releasably joined to said blade assembly by threading said coupling member to said blade assembly.

28. (canceled)

29. (canceled)

30. An adapter for use with a blender motor housing and a blade assembly, one end of the blade assembly being releasably securable to the blender motor housing for rotating the blades on the blade assembly for blending food ingredients, comprising:
a rigid, reusable container having an open upper end with an annular ledge, the interior of the container having a circular cross section dimensioned to receive a disposable cup having a lip on its upper end with the bottom of the lip seating on the annular ledge;
an annular coupling member joined at one end to the other end of the blade assembly in coaxial alignment therewith, the other end of said coupling member having an annular surface;
a mechanism releasably securing the other end of the coupling member to the upper end of the container in a closed position wherein the annular surface of the coupling member abuts the top of the lip of the cup for releasably securing the lip of the cup between the annular surface on the coupling member and the annular ledge on the container when a disposable cup is in the container and for preventing food ingredients in the disposable cup from leaking at the interface of the coupling member and the container, said mechanism comprising a hinge joining said one end of the coupling member to the upper end of the container for pivotal motion of said coupling member between said closed position and an open position wherein said coupling member is pivoted away from said container for exposing the upper end thereof.

31. The adapter of claim 30, wherein said hinge comprises a first hinge member on the coupling member and a second hinge member on the container, the first and second hinge members being releasably joinable for defining said hinge.

32. The adapter of claim 31, further comprising a latch member opposite the hinge, the latch member being pivotally attached at one end to one of the coupling member and the container and having a lock member at the other end which is releasably securable to the other one of the coupling member and the container for securing the coupling member in the closed position.

33. The adapter of claim 32, wherein the coupling member has a plurality of radially outwardly extending tabs which engage openings in the blender motor housing for activating the motor in the blender motor housing when said one end of the blade assembly is releasably secured to the blender motor housing, one of said tabs being disposed on the latch member for engagement with one of said openings in the blender motor housing only when the lock member is releasably secured to the other one of the coupling member and the container.

34. (canceled)

35. The adapter of claim 32, wherein the latch member has an arm extending outwardly therefrom for applying a pivotal force to the latch member for releasing the lock member from the recess, whereupon the coupling member is movable to the open positon by rotating the coupling member about the hinge.

36-42. (canceled)
